(19) United States
(12) Patent Application Publication
(10) Pub. No.: US 2005/0248959 A1
(43) Pub. Date: Nov. 10, 2005

(54) Light source module

(75) Inventor: Yi-Shiuan Chiou, Taipei City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: HONYI PRECISION INDUSTRY CO., LTD.

(21) Appl. No.: 10/840,241

(22) Filed: May 7, 2004

(51) Int. Cl. G02B 6/00

(52) U.S. Cl. 362/602

(57) ABSTRACT

A light source module utilized in a photoelectric scanning device for offering a light source to scan an article comprises a light emitting diode, a light guiding rod and several light reflection structures. The light reflection structure has a reflector with a specific width and depth, positioned in opposite to the light output side of the light guiding rod, further with a distance to the light emitting diode to produce a specific light intensity, in order to compensate the light aberration of the lens module.

### BACKGROUND OF THE INVENTION

1. Field of the Invention

The present invention relates to a light source module, particularly to the light source module utilized in scanners.

2. Background Description

A scanner is the device to capture images and to transmit the captured analog signal into the digital mode which can be displayed, edited, stored and output by computers.

Referring to FIG. 1, it is the schematic diagram of a known scanner. As shown in FIG. 1, the scanner is mainly built up by CCD (Charge-Coupled Device) sensing units, a fluorescent lamp, a motor, a belt (or a driven worn gear set), an analog/digital signal converter (A/D Converter), a cover and a case.

The way that scanners capture images is as: first place the origin copy on the document glass (not shown in the drawing) and close the document cover; then, with the software installed in the computer driving the motor, the belt is started to move the fluorescent lamp and to illuminate the origin copy; after the light reflection, the light beams are transmitted by a mirror to CCD sensing units; CCD sensing units can detect the varied intensity of the light beam reflected from the different areas of the origin copy and transform the intensity of the light beam into the varied intensity of the electric current; afterward the electric current is transmitted to A/D Converter, which is transforming the electric current's analog signal into the digital signal which can be recognized by the computers; finally the scanning programs which control the operation of the scanner read in all the digital signals and restructure them into a computer picture file.

The known scanner uses the fluorescent lamp to provide the light source needed while scanning; however, the light beams produced by the fluorescent lamp going through the lens group set up in the scanner causes the uneven distribution of intensity of light as shown in FIG. 2; in other words, the light on two sides is weaker and that in the middle is stronger, and it will cause CCD sensing units receives the weak reflection from the two sides of the origin copy and the scan-completed file has the indistinct two sides even the big black area, further, the content of the image being unable to be recognized leads the consequence of bad scan quality.

Thus, to develop a light source module for improving the technique stated as above is able to cost down and to reach the goal of significantly control of the intensity of light.

### SUMMARY OF THE INVENTION

It is therefore an object of the present invention to provide to a light source module which is applied to the scanners. It can overcome the traditional scanner's drawbacks as the uneven distribution of the intensity of light caused by the light source from the fluorescent lamp, the indistinct image at two sides or big black area of the picture file, and the content of the image unable to be recognized.

According to the above objects, the generalized exemplary implementation of the present invention is to provide a light source module, which is applied to the photoelectric scanning device, offers the light required by the scanner for scanning an article; the light source module includes: a light emitting object: to produce the light source; a light guide object: to guide the light produced by the light emitting object; and several light reflection blocks: to be placed on the light guide object, when the light illuminates the light guide object, these light reflection blocks reflect the light from the light emitting object and output to the article in order to keep the intensity of light in a certain status.

According to the conception of the present invention, the light emitting object is set on the side of the light guide object so that the light emitting object shoots the light to the light guide object from its side.

According to the conception of the present invention, the photoelectric scanning device is a scanner applied to capture the image of an article. The light guide object is a solid rod and is transparent.

According to the conception of the present invention, the light emitting object is a white light emitting diode.

According to the conception of the present invention, the light reflection blocks are placed against the light output side of the light guide rod.

According to the conception of the present invention, the light reflection blocks are the reflectors with a specific width and a specific depth; with their width and depth and the distance from the light emitting object, there accomplishes the output of the consistent intensity of light.

According to the conception of the present invention, the reflection blocks are distributed relatively to the mid of the light guide rod.

According to the conception of the present invention, the depth of the light reflection blocks is in the central section of the light guide rod and close to the light output side of the light guide rod.

In order to meet the goals stated above, another light source module exemplary implementation of the present invention includes: a LED: to create the light source; a light guide object: to guide the light created by the LED; a light reflection block: a reflector with a specific width and a specific depth, which is placed against the light output side of the light guide object; with its width and depth and the distance from the LED, there accomplishes the output of the consistent intensity of light.

According to the conception of the present invention, the light guide object is a solid rod.

According to the conception of the present invention, the LED is a white LED.

According to the conception of the present invention, the reflection block is distributed relatively to the mid of the light guide rod.

According to the conception of the present invention, the depth of the light reflection block is in the central section of the light guide rod and close to the light output side of the light guide rod.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic diagram of a known scanner;

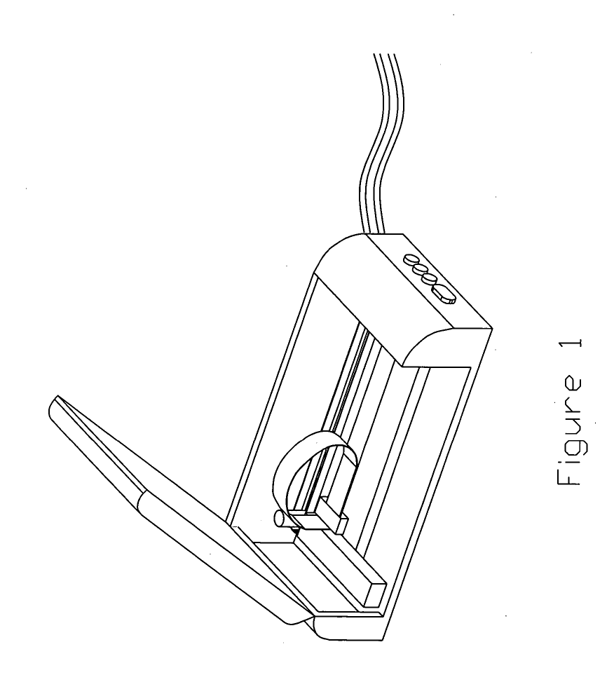

FIG. 2 is the distribution chart of the light intensity of the fluorescent lamp;

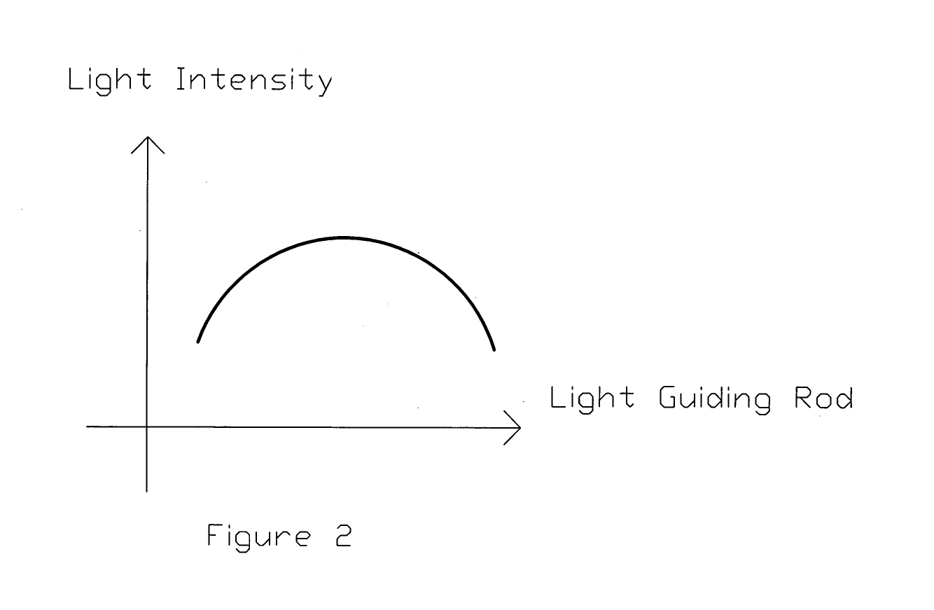

FIG. 3 is the diagram of the light source module of the first embodiment of the present invention;

FIG. 4 is the diagram of the light intensity of the second embodiment;

FIG. 5 is the diagram showing the reflection by the reflection structure of the present invention;

FIG. 6 is the schematic diagram combined with the light intensity pattern of the second embodiment of the present invention; and

FIG. 7 is the schematic diagram combined with the light intensity pattern of the third embodiment of the present invention; and

### DETAILED DESCRIPTION OF A PREFERRED EMBODIMENT OF THE INVENTION

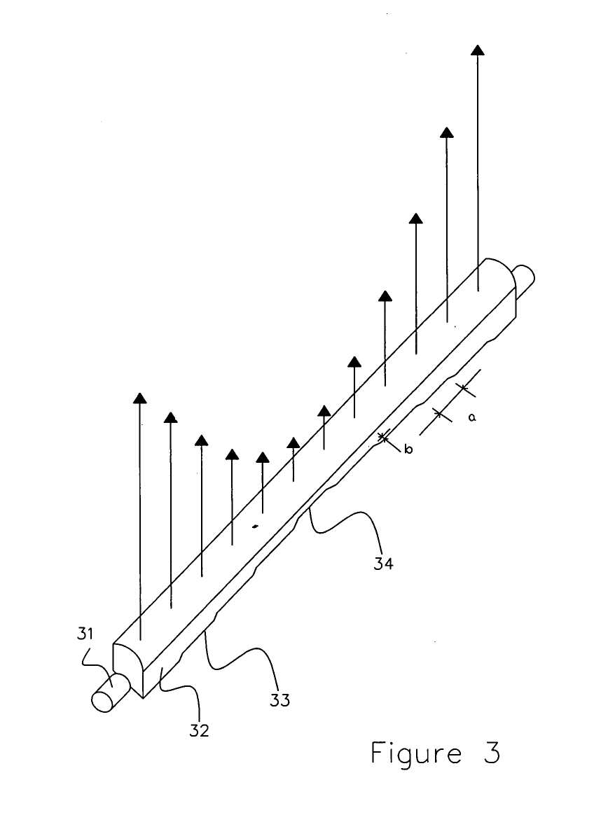

FIG. 3 is the diagram showing the first embodiment of the present invention. The light source module of the present invention consists of a LED (Light Emitting Diode) 31, a light guide rod 32 and several light reflection structures 33, 34. It can be applied to a photoelectric scanning device for the purpose of offering the light source needed to scan an article or a document. With the arrangement of the light reflection structures, the intensity of light from the source to the article can be adjusted. The photoelectric scanning device is a scanner, but without limits.

In the light source module of the present invention, the emitting unit is the light emitting diode (LED) 31, which is set on the side of the light guide rod 32, thus the LED 31 projects light to the side of the light guide rod 32. If LEDs are set on both sides of the light guide rod, it certainly brings out a better luminosity.

The light guide rod 32 is made of the common material as a light guide plate in the TFT display industry, utilized to guide the light generated by the LED 31; the light reflection structures 33, 34 are set up on the light guide rod 32, the reflection surfaces are with the varied width (as Legend “a”), and the varied depth (or height as Legend “b”). With the different width and depth of the light reflection structures, there accomplishes the output of the consistent intensity of light. Hence, from the design point of view, the distribution and the property of the light reflection structures can be adjusted and arranged to the first light reflection structure 33 and the second light reflection structure 34 shown in FIG. 3.

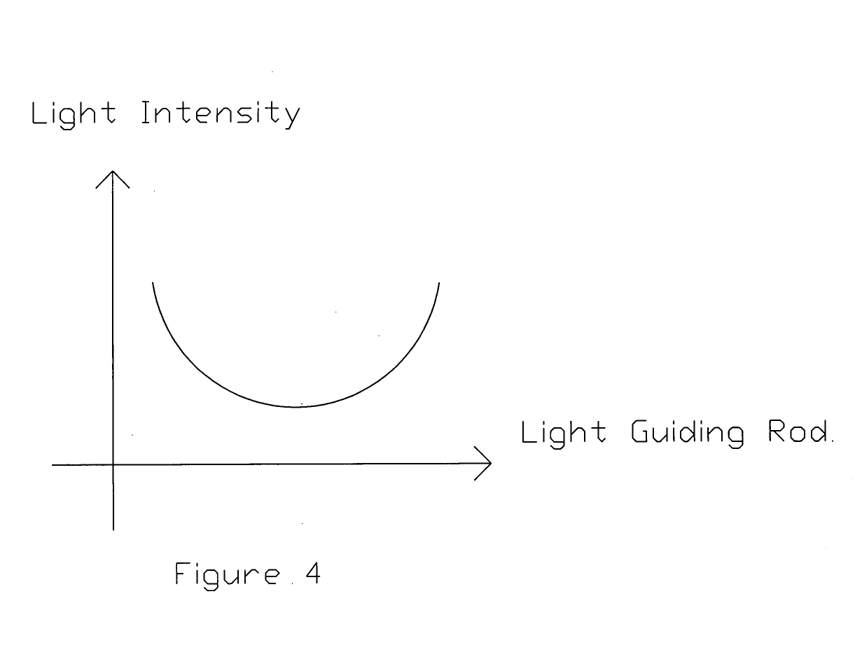

Further in FIG. 3, the second light reflection structure 34 is away from the LED and its depth of is relatively deep, so the intensity of light in the mid of the light guide rod 32 is weaker, it can effectively make up the aberration caused by the traditional lenses group application on the scanner; meanwhile, to set the first light reflection structure 33 on a proper place can decrease the output of the intensity of light from the light source module while approaching the middle. Therefore, the application of the present invention is stated as: by adjusting the parameters of the arrangement, distribution, width and depth of the light reflection structures, the light source module is capable of providing a specific intensity pattern of the output of light source; it cannot only compensate the attenuation of the intensity of light from the typical image capturing module but also be applied to the product with a request of the output of the special intensity of light. The arrangement as shown in FIG. 4, for example, is able to enhance the light source on both two sides. Therefore, it improves the property and performance of the prior known optical lens module.

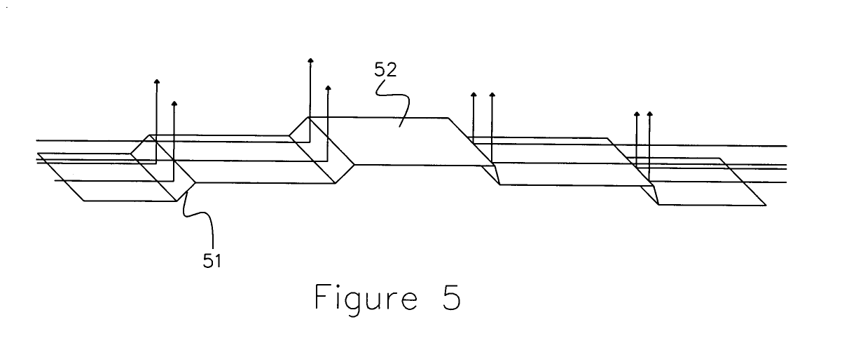

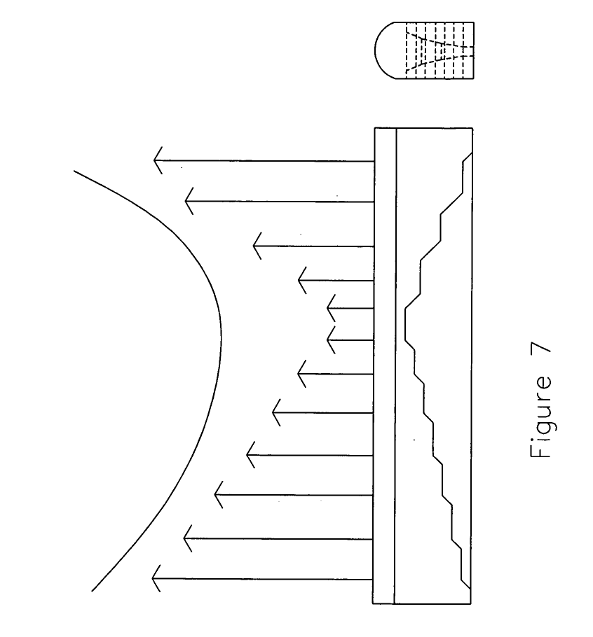

In regard to the light improvement and the design of the output of the consistent intensity of the light source module of the present invention, the theory, as shown in FIG. 5, is to utilize reflection surface 51 to guide the reflection to the light output side, so the angle and the depth of the reflection surface 51 are able to control the properties and patterns of the intensity of light reinforced by the reflection structure; similarly, the length and width of the light guide surface 52 are controllable in the design phase. It makes the output from the light guide surface more even. In the present invention, the light guide surface is relatively parallel with the light output side; however, it can be designed with a small angle to keep a bit distance from the reflection surface 51. Again, as shown in FIG. 5, in case the light source (as LED) is set on both sides of the light guide rod, the light reflection structures can be set up from the relative central point to both sides. Unless there is other requirement about the intensity of light source module, the unsymmetrical distribution can be adopted in order to perform the special pattern of intensity further to compensate the optics physics lacks of optical lens group, refer to FIG. 7.

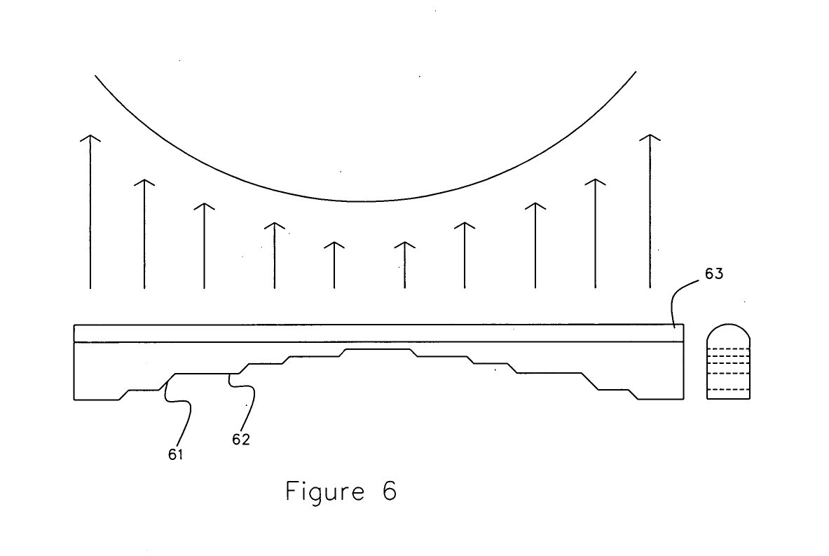

FIG. 6 is the diagram of the second embodiment of the present invention. The height of the light reflection surface 61 is extremely small, but the quantity of the reflection surface is a bit more, relatively, the light guide surfaces 62 are evenly distributed according to the light output side 63. The effect of such light source modules is that the intensity of light output side would be gentle because the more the light reflection surface 61 and light guide surface 62 are distributed the better the consistency of the pattern of intensity. Contrarily, upon the request of the special light output, the reflector's width and depth are adjustable in the reflection structure of the light source module in the present invention in order to meet the request of the special intensity of light. Refer to FIG. 7 of the third embodiment for the unsymmetrical distribution of the patter of intensity.

Besides, the light emitting objects as above can be set on the both sides of the light guide stuff for the purposes of the high intensity of light or the need to balance the intensity of light. Plus, the light guide stuff shown in the drawing is a solid rod, which can be made of the other materials, or be the other shapes such cylindrical hollow object, semicircle, arc and so on. Moreover, the light guide structure can be built up inside of the light guide object to support the more consistent light guiding to the light guide object or rod, and it also assists the light source device of the present invention in better controlling of the intensity of light.

Surely, the LED in the light source module of the present invention has the other alternatives as the white light LED, red light LED, green light LED, blue light LED or even their combination.

The light source module of the present invention, with setting the reflection structures on the light output side (not shown in the drawing) of the light guide object or on the light input side, it's indeed to keep the consistently distributed intensity of the light illuminating to the scanner and further to solve the drawbacks of the known techniques. In addition, by combining the different types of reflection structures or adjusting the location and the density of the reflection structures distributed on the light guide plate, it can control the distribution of the intensity of light output from the light source to meet the requirements upon the various photoelectric scanning devices.

Although preferred embodiments of the present invention have been described in the forgoing description and illustrated in the accompanying drawings, it will be understood that the invention is not limited to the embodiments disclosed, but is capable of numerous rearrangements, modifications, and substituting of parts and elements without departing from the spirit and scope of the invention. Accordingly, the present invention is intended to encompass such rearrangements, modifications, and substitutions of parts and elements as fall within the scope of the appended claims.

1. A light source module comprising:
a light emitting device for providing a light source;
a light guiding device for guiding light of said light source; and
a plurality of reflection portions, formed on said light guiding device, for reflecting said light as an output with a light intensity pattern, in order to compensate aberration of a lens module.

2. The light source module of claim 1, wherein said light emitting device is positioned at the side of said light guiding device.

3. The light source module of claim 1, wherein said light intensity pattern consists of a weaken light intensity in the middle.

4. The light source module of claim 1, wherein said light guiding device is a transparent solid rod.

5. The light source module of claim 1, wherein said light emitting device is a light emitting diode.

6. The light source module of claim 1, wherein said light reflection portion is positioned in opposite to a light output side of said light guiding device.

7. The light source module of claim 1, wherein said light reflection portion comprises a reflection surface with a predetermined width and a predetermined depth.

8. The light source module of claim 7, wherein said output is consistent by arranging said width, said depth and further a distance to said light emitting device.

9. The light source module of claim 1, wherein said light reflection portions are evenly distributed from the center of said light guiding device.

10. The light source module of claim 6, wherein a middle light reflection portion is close to said light output side of said light guiding device.

11. A light source module, comprising:
a light emitting diode for providing a light source;
a light guiding rod for guiding light of said light source; and
a light reflection block, having a reflector with a width and a depth, positioned in opposite to
a light output side of said light guiding rod, further with a distance to said light emitting diode to produce a predetermined light intensity.

12. The light source module of claim 11, wherein the arrangement of said light reflection block is an even distribution counting from the center of said light guiding rod.

13. The light source module of claim 11, wherein a middle light reflection portion is close to said light output side of said light guiding rod.
